(19) United States
(12) Patent Application Publication
(10) Pub. No.: US 2011/0057636 A1
(43) Pub. Date: Mar. 10, 2011

(54) Method for Reducing Energy Loss in DC-DC Converter and Related Control Device and DC-DC Converter

(76) Inventors: Yang-Fan Su, Tainan City (TW); Wen-Hsiu Huang, Miaoli County (TW)

(21) Appl. No.: 12/636,770

(22) Filed: Dec. 13, 2009

(30) Foreign Application Priority Data
Sep. 9, 2009 (TW) 098130333

(51) Int. Cl. G05F 1/656

(52) U.S. Cl. 323/285

(57) ABSTRACT

A method for reducing energy loss in a DC-DC converter comprises detecting an output current of the DC-DC converter to generate a sensing signal, adjusting a frequency of an oscillation signal, comparing a reference signal and a feedback signal of the DC-DC converter to generate a comparison result, comparing the comparison result and the oscillation signal to generate a PWM signal, and determining whether an input end of the DC-DC converter is electrically connected to an output end of the DC-DC converter according to the PWM signal.

### BACKGROUND OF THE INVENTION

1. Field of the Invention

The present invention is related to a method for reducing energy loss in a DC-DC converter and related control device and DC-DC converter, and more particularly, to a method capable of reducing energy loss in a DC-DC converter by adjusting a switching frequency thereof and related control device and DC-DC converter.

2. Description of the Prior Art

An electronic device generally includes various components requiring different operating voltages. Therefore, a DC-DC voltage converter is essential for the electronic device to adjust (step up or step down) and stabilize voltage levels. Based upon different power requirements, various types of DC-DC voltage converter, originating from a buck (step down) converter and a boost (step up) converter, are developed. Accordingly, the buck converter can decrease an input DC voltage to a default voltage level, and the boost converter can increase an input DC voltage. With advances in circuit technology, both of the buck and boost converters are varied and modified to conform to different system architectures and requirements.

For example, please refer to FIG. 1, which is a schematic diagram of a buck converter 10 of the prior art. The buck converter 10 includes an input end 100, a lowpass module 110, a control module 120, a switch module 130, an output end 140, an output module 150 and a feedback module 160. The input end 100 is utilized for receiving a first input voltage VIN1. The lowpass module 110 is composed of an input inductor 112 and an input capacitor 114, and is utilized for filtering out high frequency components of the first input voltage VIN1 to generate a second input voltage VIN2. The control module 120 is a pulse width modulation (PWM) controller for generating a PWM signal VPWM sent to the switch module 130 according to the second input voltage VIN2 and a feedback signal VFB of the output end 140. The switch module 130 includes an up-bridge switch transistor 132, a down-bridge switch transistor 134, an amplifier 136 and an inverter 138, and is utilized for determining whether or not to enable the up-bridge switch transistor 132 and the down-bridge switch transistor 134 based upon the PWN signal (and an inverted PWM signal), so as to adjust a current of a node N1. The output module 150 coupled to the node N1 is composed of an output capacitor 152 and an output inductor 154, and is utilized for generating an output voltage VOUT by frequency response of the out inductor 152 and the output capacitor 154. In short, the control module 120 adjusts the output voltage VOUT by varying duty cycles of the up-bridge switch transistor 132 and the down-bridge switch transistor 134.

However, due to undesired effects caused by manufacturing process errors, physical properties of components, etc., parasitic components essentially exist in the switch module 130, and lead to a performance decline in the buck converter 10. For example, when the buck converter 10 operates in a light load state (with a low output current IOUT), a “switching loss” is the major cause of the performance decline in the buck converter 10. In detail, when the switch module 130 performs switching operations, gate voltages of the up-bridge switch transistor 132 and the down-bridge switch transistor 134 cannot instantaneously hit a desired level due to parasitic gate capacitors thereof, but increase or decrease smoothly, implying a large resistor R_{DS} existing between drains and sources of the up-bridge switch transistor 132 and the down-bridge switch transistor 134 as well as an extra energy loss. Furthermore, the parasitic capacitors are charged and discharged during the switching operation, leading to another energy loss. Note that the switching loss is directly proportional the switching frequency. That is, the energy loss becomes more severe with increased switching times.

Thus, in order to reduce the switching loss, the buck converter 10 has to decrease the switching frequency of the PWM signal VPWM. However, without additional modifications, a load variation resistance of the output voltage VOUT drops with the switching frequency. For example, if demand for the output current IOUT explodes, a smoothly changing switching frequency leads to smoothly changing charging/discharging frequency of the output capacitor 152, as well as an unstable output voltage VOUT. Moreover, in the buck converter 10, the switching frequency of the PWM signal VPWM is determined by an oscillator (e.g. a crystal oscillator) of the control module 120, and therefore is fixed. That is, the switching loss of the buck converter 10 cannot be reduced by adjusting the switching frequency.

Therefore, how to reduce the energy loss of the DC-DC converter to enhance performance by timely adjustment of the switching frequency has been a major area of research in industry.

### SUMMARY OF THE INVENTION

It is therefore a primary objective of the claimed invention to provide a method for reducing energy loss in a DC-DC converter and related control device and DC-DC converter.

The present invention discloses a method for reducing energy loss in a DC-DC converter. The method comprises detecting an output current of the DC-DC converter to generate a sensing signal, adjusting a frequency of an oscillation signal according to the sensing signal, comparing a reference signal and a feedback signal of the DC-DC converter to generate a comparison result, comparing the comparison result and the oscillation signal to generate a pulse width modulation (PWM) signal, and determining whether or not an input end of the DC-DC converter is electrically connected to an output end of the DC-DC converter according to the PWM signal.

The present invention further discloses a control device for a DC-DC converter comprising a sensor for detecting an output current of the DC-DC converter to generate a sensing signal, an oscillator, for adjusting a frequency of an oscillation signal according to the sensing signal, a first comparator for comparing a reference signal and a feedback signal of the DC-DC converter to generate a comparison result, and a second comparator for comparing the comparison result and the oscillation signal to generate a pulse width modulation (PWM) signal to the DC-DC converter, so as to determine whether or not an input end of the DC-DC converter is electrically connected to an output end of the DC-DC converter.

The present invention further discloses a DC-DC converter comprising an input end for receiving an input voltage, an output end for outputting an output voltage, a feedback module coupled to the output end for generating a feedback signal according to the output voltage, a switch module comprising a first end for receiving a pulse width modulation (PWM) signal, a second end, an up-bridge switch transistor coupled to the input end, the first end and the second end for determining whether or not the input end is electrically connected to the second end, and a down-bridge switch transistor coupled to the first end the second end and a ground end for determining whether or not the second end is electrically connected to the ground end according to an inverted signal of the PWM signal, an output module comprising, an output inductor comprising one end coupled to the second end of the switch module and another end coupled to the output end, and an output capacitor comprising one end coupled to the output end and another end coupled to the ground end, and a control device comprising a sensor for detecting the output current to generate a sensing signal, an oscillator for adjusting a frequency of an oscillation signal according to the sensing signal, a first comparator for comparing a reference signal and a feedback signal of the DC-DC converter to generate a comparison result, and a second comparator for comparing the comparison result and the oscillation signal to generate the PWM signal sent to the switch module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a buck converter of the prior art.

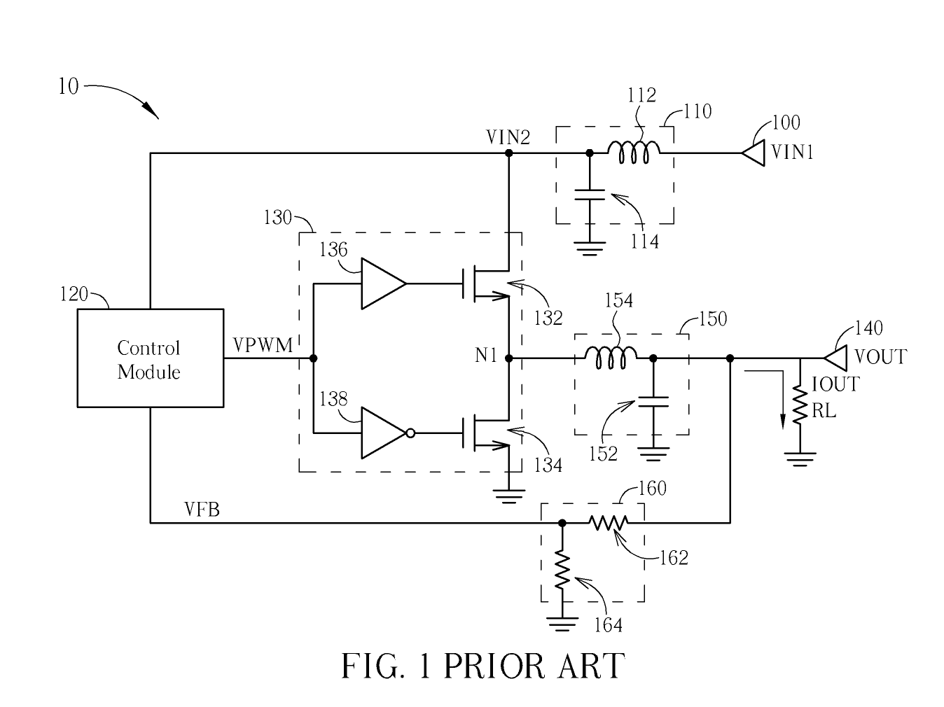

FIG. 2 is a schematic diagram of a DC-DC converter according to an embodiment of the present invention.

FIG. 3 is a schematic diagram of a process according to an embodiment of the present invention.

### DETAILED DESCRIPTION

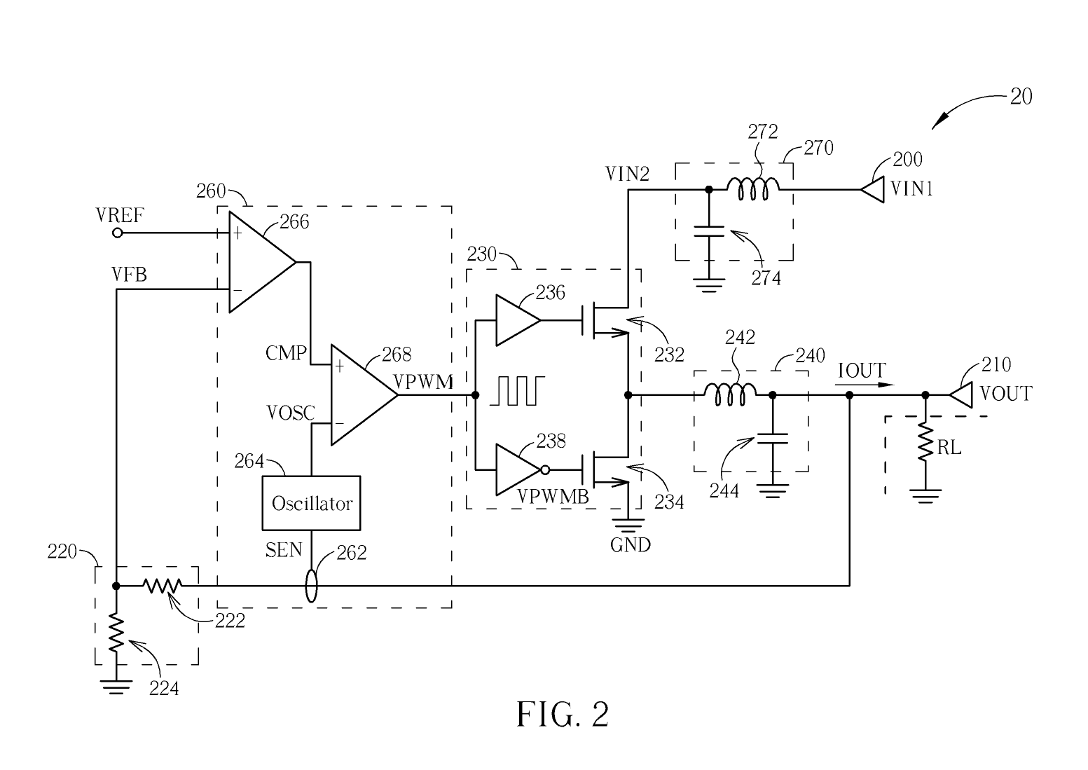

Please refer to FIG. 2, which is a schematic diagram of a DC-DC converter 20 according to an embodiment of the present invention. The DC-DC converter 20 includes an input end 200, an output end 210, a feedback module 220, a switch module 230, an output module 240, a control device 260 and a lowpass module 270. The input end 200 is utilized for receiving a first input voltage VIN1. The lowpass module 270 comprises an input inductor 272 and an input capacitor 274, and is utilized for filtering out high frequency components of the first input voltage VIN1 to generate a second input voltage VIN2. The output end 210 is utilized for outputting an output voltage VOUT. The feedback module 220 is utilized for generating a feedback signal VFB according to the output voltage VOUT. The switch module 230 includes an up-bridge switch transistor 232, a down-bridge switch transistor 234, an amplifier 236 and an inverter 238. The amplifier 236 is utilized for amplifying a pulse width modulation (PWM) signal VPWM. The inverter 238 is utilized for amplifying the PWM signal VPWM and generating an inverted signal VPWMB of the PWM signal VPWM. The up-bridge switch transistor 243 is utilized for determining whether or not the input end 200 is electrically connected to the output module 240 based upon the PWM signal VPWM. The down-bridge switch transistor 234 is utilized for determining whether or not the output module 240 is electrically connected to a ground end GND based upon the inverted signal VPWMB. The output module 240 includes an output inductor 242 and an output capacitor 244, and is utilized for generating the output voltage VOUT. The control device 260 includes a sensor 262, an oscillator 264, a first comparator 266 and a second comparator 268. The sensor 262 is utilized for detecting an output current IOUT of the DC-DC converter 20 to generate a sensing signal SEN. The oscillator 264 is utilized for adjusting a frequency of an oscillation signal VOSC based upon the sensing signal SEN. The first comparator 266 is utilized for comparing a reference signal VREF and the feedback signal VFB to generate a comparison result CMP. Finally, the second comparator 268 is utilized for comparing the comparison result CMP and the oscillation signal VOSC to generate the PWM signal VPWM sent to the switch module 230, so as to determine whether or not the input end 200 is electrically connected to the output end 210.

In short, according to the present invention, since a “switching loss” of the DC-DC converter 20 is directly proportional to a switching frequency of the switch module 230, a frequency of the PWM signal VPWM is adjusted based upon load variation of the DC-DC converter 20 to adjust the switching frequency of the switch module 230, so as to reduce the switching loss of the DC-DC converter 20. In other words, the present invention “customizes” the switching frequency of the switch module 230 according to the output current IOUT to reduce energy loss during switching operations.

For example, since the switching loss is the major cause of energy loss when the DC-DC converter 20 operates in a light load state (with a low output current IOUT), the oscillator 244 preferably decreases the frequency of the oscillation signal VOSC to reduce the switching loss when the sensing signal SEN indicates that the output current IOUT lessens. The decreased switching frequency (decreased charging/discharging frequency of the output capacitor 244) does not lead to an unstable output voltage VOUT since level of the output current IOUT required is lower in the light load state.

In addition, when the sensing signal SEN indicates that the output current IOUT is zero, the oscillator 244 can preferably decrease the frequency of the oscillation signal VOSC to a minimum switching frequency when the sensing signal SEN indicates that the output current IOUT is zero.

Note that, in general, the sensing signal SEN is directly proportional to the output current IOUT, and the oscillation signal VOSC is a sawtooth signal. Methods for sensing the output current IOUT are well known to those skilled in the art and not further narrated herein.

Moreover, the feedback module 220 preferably includes a first resistor 222 and a second resistor 224, and is utilized for generating a divided voltage of the output voltage VOUT to be the feedback signal VFB. Certainly, those skilled in the art can generate the feedback signal VFB through different methods based upon specific requirements, e.g. by directly feeding back the output voltage VOUT without any other processing.

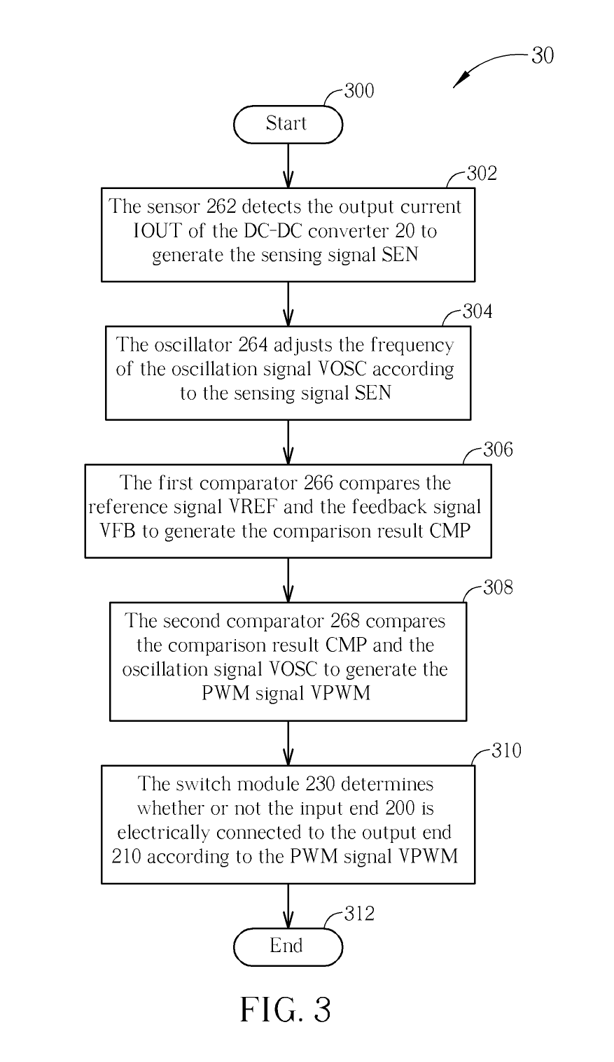

Operations of the DC-DC converter 20 and the control device 260 can be summarized into a process 30, as illustrated in FIG. 3. The process 30 is utilized for reducing energy loss of the DC-DC converter 20, and includes the following steps:

Step 300: Start.

Step 302: The sensor 262 detects the output current IOUT of the DC-DC converter 20 to generate the sensing signal SEN.

Step 304: The oscillator 264 adjusts the frequency of the oscillation signal VOSC according to the sensing signal SEN.

Step 306: The first comparator 266 compares the reference signal VREF and the feedback signal VFB to generate the comparison result CMP.

Step 308: The second comparator 268 compares the comparison result CMP and the oscillation signal VOSC to generate the PWM signal VPWM.

Step 310: The switch module 230 determines whether or not the input end 200 is electrically connected to the output end 210 according to the PWM signal VPWM.

Step 312: End.

Details of the process 30 can be referred in the above, and are not further narrated herein.

In the prior art, the switching frequency of the switch module 130 is fixed, and cannot be varied based upon different load states of the buck converter 10. That is, without further modifications, the buck converter 10 cannot reduce energy loss caused by switching operations through adjusting the switching frequency. In comparison, according to the present invention, the switching frequency of the switch module 230 is varied based upon load variation, such that the energy loss caused by switching operations in the DC-DC converter 20 can be effectively reduced, especially in a light load state.

To sum up, the present invention reduces energy loss of the DC-DC converter by adjusting the switching frequency of the DC-DC converter during switching operations, so as to enhance performance of the DC-DC converter.

Those skilled in the art will readily observe that numerous modifications and alterations of the device and method may be made while retaining the teachings of the invention.

What is claimed is:

1. A method for reducing energy loss in a DC-DC converter, the method comprising:
detecting an output current of the DC-DC converter to generate a sensing signal;
adjusting a frequency of an oscillation signal according to the sensing signal;
comparing a reference signal and a feedback signal of the DC-DC converter to generate a comparison result;
comparing the comparison result and the oscillation signal to generate a pulse width modulation (PWM) signal; and
determining whether or not an input end of the DC-DC converter is electrically connected to an output end of the DC-DC converter according to the PWM signal.

2. The method of claim 1, wherein the step of adjusting the frequency of the oscillation signal according to the sensing signal comprises decreasing the frequency of the oscillation signal when the sensing signal indicates that the output current lessens.

3. The method of claim 1, wherein the step of adjusting the frequency of the oscillation signal according to the sensing signal comprises decreasing the frequency of the oscillation signal to a minimum switching frequency when the sensing signal indicates that the output current is zero.

4. The method of claim 1, wherein the sensing signal is directly proportional to the output current.

5. The method of claim 1, wherein the oscillation signal is a sawtooth signal.

6. A control device for a DC-DC converter comprising:
a sensor, for detecting an output current of the DC-DC converter to generate a sensing signal;
an oscillator, for adjusting a frequency of an oscillation signal according to the sensing signal;
a first comparator, for comparing a reference signal and a feedback signal of the DC-DC converter to generate a comparison result; and
a second comparator, for comparing the comparison result and the oscillation signal to generate a pulse width modulation (PWM) signal to the DC-DC converter, so as to determine whether or not an input end of the DC-DC converter is electrically connected to an output end of the DC-DC converter.

7. The control device of claim 6, wherein the oscillator decreases the frequency of the oscillation signal when the sensing signal indicates that the output current lessens.

8. The control device of claim 6, wherein the oscillator decreases the frequency of the oscillation signal to a minimum switching frequency when the sensing signal indicates that the output current is zero.

9. The control device of claim 6, wherein the sensing signal is directly proportional to the output current.

10. The control device of claim 6, wherein the oscillation signal is a sawtooth signal.

11. A DC-DC converter comprising:
an input end, for receiving an input voltage;
an output end, for outputting an output voltage;
a feedback module, coupled to the output end, for generating a feedback signal according to the output voltage;
a switch module comprising:
a first end, for receiving a pulse width modulation (PWM) signal;
a second end;
an up-bridge switch transistor, coupled to the input end, the first end and the second end, for determining whether or not the input end is electrically connected to the second end; and
a down-bridge switch transistor, coupled to the first end, the second end and a ground end, for determining whether or not the second end is electrically connected to the ground end according to an inverted signal of the PWM signal;
an output module comprising:
an output inductor, comprising one end coupled to the second end of the switch module, and another end coupled to the output end; and
an output capacitor, comprising one end coupled to the output end, and another end coupled to the ground end; and
a control device comprising:
a sensor, for detecting the output current to generate a sensing signal;
an oscillator, for adjusting a frequency of an oscillation signal according to the sensing signal;
a first comparator, for comparing a reference signal and a feedback signal of the DC-DC converter to generate a comparison result; and
a second comparator, for comparing the comparison result and the oscillation signal to generate the PWM signal sent to the switch module.

12. The DC-DC converter of claim 11, wherein the oscillator decreases the frequency of the oscillation signal when the sensing signal indicates that the output current lessens.

13. The DC-DC converter of claim 11, wherein the oscillator decreases the frequency of the oscillation signal to a minimum switching frequency when the sensing signal indicates that the output current is zero.

14. The DC-DC converter of claim 11, wherein the sensing signal is directly proportional to the output current.

15. The DC-DC converter of claim 11, wherein the oscillation signal is a sawtooth signal.

16. The DC-DC converter of claim 11 further comprising:
an input inductor, comprising one end coupled to the input end, and another end coupled to the up-bridge switch transistor; and
an input capacitor, comprising one end coupled between the input inductor and the up-bridge switch transistor, and another end coupled to the ground end.

17. The DC-DC converter of claim 11, wherein the switch module further comprises:
an amplifier, coupled between the first end and the up-bridge switch transistor, for amplifying the PWM signal; and
an inverter, coupled between the first end and the down-bridge switch transistor, for amplifying the PWM signal and generating the inverted signal of the PWM signal.

18. The DC-DC converter of claim 11, wherein the feedback module comprises:
a first resistor, comprising one end coupled to the output end, and another end coupled to the first comparator; and
a second resistor, comprising one end coupled between the first resistor and the first comparator, and another end coupled to the ground end.
